(19) United States
(12) Patent Application Publication
(10) Pub. No.: US 2006/0169106 A1
(43) Pub. Date: Aug. 3, 2006

(54) Compression nut removal device

(76) Inventor: Brian J. Fitpatrick, Yorba Linda, CA (US)

Correspondence Address: MICHAEL A. SHIPPEY, PH. D., 4848 LAKEVIEW AVENUE, SUITE B, YORBA LINDA, CA, 92886, US

(21) Appl. No.: 11/051,940

(22) Filed: Feb. 3, 2005

(51) Int. Cl. B25B 13/48; B25B 13/02; B23P 19/04

(52) U.S. Cl. 81/55; 81/119; 29/260

(57) ABSTRACT

The present invention is an embodiment of a machine-enabled compression nut removal device. The Compression Nut Puller of the present invention features a shaft attachment for the insertion of a mechanized hand drill to enable swift and easy removal of heavily torqued compression nuts. There has been a need for the ease provided by this machine assistance, as prior art has not developed a drill-assisted compression nut puller. The present invention features a base support plate with the enhanced compression removal assistance of two support pillars and a pipe attachment sleeve. This quickly rotates the axle of the shaft while the supports remain stationary, which enables the quick removal of a tightly compressed nut, whether it is deformed, corroded, or otherwise damaged.

### INTRODUCTION

The present invention is an embodiment of a machine-enabled compression nut removal device. The Compression Nut Puller of the present invention features a shaft attachment for the insertion of a mechanized hand drill to enable swift and easy removal of heavily torqued compression nuts. There has been a need for the ease provided by this machine assistance, as prior art has not developed a drill-assisted compression nut puller.

The present invention features a base support plate with the enhanced compression removal assistance of two support pillars and a pipe attachment sleeve. This quickly rotates the axle of the shaft while the supports remain stationary, which enables the quick removal of a tightly compressed nut, whether it is deformed, corroded, or otherwise damaged.

### FIELD OF THE INVENTION

The present invention relates to the field of plumbing tools, and more specifically to the field of machine-powered plumbing tools used for the removal of heavily torqued compression nuts.

### BACKGROUND ART

Prior art has seen developed various devices used for the removal of compression nuts and gaskets once they have been attached to the end of a water pipe and screwed down to their given torque specifications. A standard faucet utilizes the rear threads to apply pressure, which seals the compression gasket securely to the nut, while the outside diameter grips the pipe to keep it from rotating and thereby loosening itself off of the faucet.

Although this provides the most secure bonding for the present application, this presents the formidable task of removing the nut once it has become corroded and/or deformed due to the extended time of pressure.

Another problem presented by this application is the difficulty of nut removal without scarring or deforming the pipe in some way, making the insertion and sealing of a new washer impossible. On many occasions, plumbers are left with no other option than to saw off the rear end of a compression washer. Unfortunately, this method for circumventing the problem can only be utilized so many times, and is destructive of otherwise perfectly functional water lines.

### BRIEF SUMMARY OF THE INVENTION

The present invention has been developed to provide machine-enhanced removal of compression nuts. It is equipped with a shaft for the attachment of a machine-powered hand drill at one end, which will propel the turning axle of the upper support plate that houses the pipe attachment sleeve.

There are two support pillars projecting from the downward end of the upper support plate and ending in a connection to the base support plate. When a hand drill is inserted into the shaft attachment, the added strength of machine-powered assistance is enabled.

An advantage of the present invention is that it facilitates the removal of stuck or frozen nuts.

Another advantage of the present invention is that it exerts more force than common hand wrenches used traditionally to unstuck frozen nuts or screw heads.

Yet another advantage of the current invention is that it helps to prevent skinned or injured fingers and hands, as commonly occurs in stuck plumbing fixture situations of the type described herein.

Still another advantage of the current invention is that it is easily fitted with different power sources, to facilitate job with different torque requirements.

Yet another advantage of the current invention is to allow adaptability to accommodate various sizes of pipes and of compression nuts.

Further objects and advantages will become apparent from a consideration of the ensuing description and drawings. Note that not all embodiments of the current invention may accomplish all of the above objectives in a single embodiment. Taken as a whole, the objectives are met through different embodiments of the invention.

### BRIEF DESCRIPTION OF DRAWINGS

FIG. 1: A side plan view of the present embodiment in use, showing proper loosening of nut from pipe in process.

FIG. 2: An angled view of a prior art supply plumbing fixture showing compression attachments.

FIG. 3: An angled view of the present embodiment without bolt, nut, or drill.

FIG. 4: An angled view of the present embodiment in use with a hand drill attached showing proper loosening of nut from pipe in process. The hand drill is shown in dotted lines, and is not part of the current invention.

FIG. 5: A top view of the present embodiment.

### DETAILED DESCRIPTION OF THE INVENTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as representative basis for teaching one skilled in the art to employ the present invention in virtually any appropriately detailed system, structure or manner.

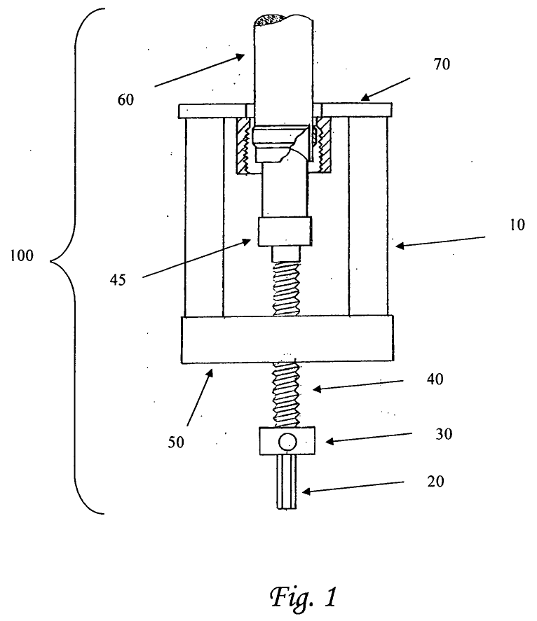

FIG. 1: A side view of the present embodiment without a drill present. This present embodiment utilizes motorized assistance by way of an ordinary hand drill (not shown in this figure) connecting to the shaft 20, by insertion into the chuck of the drill, in the same manner as a drill bit is inserted therein. The locking collar 30 aids in securing the invention to the drill. When the drill is operated, it turns the shaft 20, which turns the turning axle 40 to loosen the compression nut. This design utilizes both upper support plate 50 and base support plate 70 in addition to both support pillars 10 to create an extra rigid and solid platform to loosen even the most stubborn compression nuts. The pipe attachment sleeve 45 is placed upon the threaded pipe with the stubborn nut with ample pressure. The base support plate 70 is positioned on the opposing side of the stubborn nut 64 with ample pressure. This process, with the aid of a hand drill 90 and both support pillars 10, exerts enough pressure and support to safely remove most stubborn or corroded nuts.

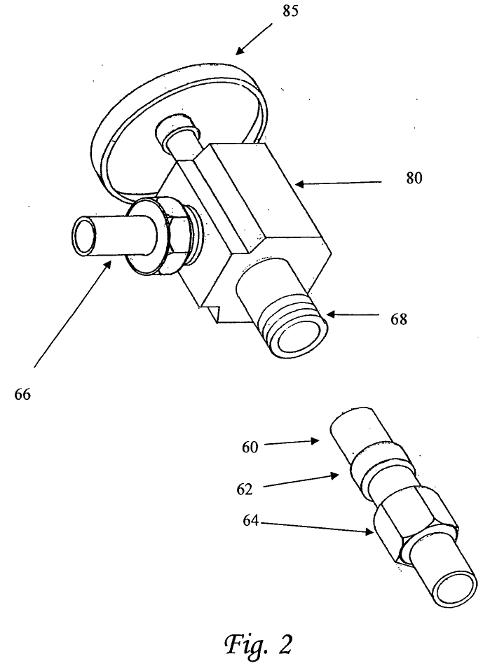

FIG. 2: This is a drawing of a prior art plumbing fixture containing a compression nut. This particular drawing portrays a water supply fixture, as is commonly found underneath sinks in the kitchen and bathroom. The water from the wall pipes exits pipe 60, which is connected to pipe 68 by means of a threaded connection, the male thread on the end of connector pipe 68, and the female thread inside compression nut 64. There is further a compression ferrule 62 on pipe 60, to help prevent leaks. The water in pipe 68 is delivered to valve body 80. Knob 85 controls the valve (not shown) inside body 80. When the knob 85 is placed in the closed position, no water flows beyond the supply valve. When the knob 85 is turned to an open position, water moves further into tube 66, which delivers water to the faucet. Faucet controls (not shown) then deliver water for use in the sink.

The problem that the present invention is designed to solve is illustrated by this figure. Compression nut 64 is designed to compress down upon ferrule 62 when being threaded upon the thread on pipe 68. This creates a tight seal, which is designed to prevent water leaking out of the junction of pipe 60 and pipe 68. However, the compression nut 64 and 62 ferrule can perform their appointed task too well. After many years of use, in a continuously wet environment (remember that water stops at the valve in 80, well beyond the compression fitting), compression nut 64 can become fixed in place, and virtually impossible to loosen, or indeed turn at all.

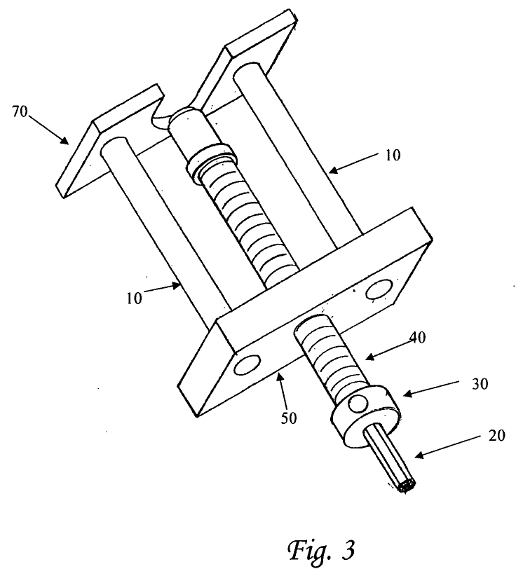

FIG. 3: This figure shows the device of the present invention from an angled perspective, without attachments, such as a hand drill. The hand drill or other power source, or even a hand-turned handle, is attached at shaft 20. Locking collar 30 is present to ensure the shaft 20 is firmly attached to axle 40. At the other end of axle 40 is pipe attachment sleeve 45. This sleeve also is firmly attached to axle 40. The sleeve can engage a water supply pipe upon being inserted therein. At the same time, the lower plate 70 is placed such that a nut on said water pipe will be engaged by the cutout area in the plate. When the shaft 20 is turned, thus turning axle 40 and pipe attachment sleeve 45, force is applied to the nut to force it to turn, and thus release its grip on the pipe.

Note that the sleeve 45 can be replaced by another sleeve of different diameter, in order to accommodate a pipe of unusual diameter. In the same manner, lower base plate 70 can be exchanged for a similar plate with a different size of cutaway area, in order to engage nuts of differing sizes.

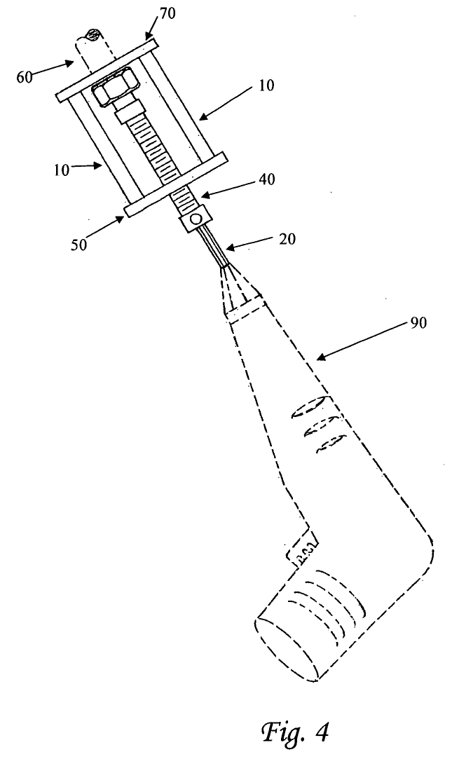

FIG. 4: An angled view of the present embodiment which utilizes motorized assistance by way of an ordinary hand drill 90 connecting to the shaft 10 which turns the turning axle 40 to loosen the compression nut 64. This design utilizes both upper support plate 50 and base support plate 70 in addition to both support pillars 10 to create an extra rigid and solid platform to loosen even the most stubborn compression nuts. The pipe attachment sleeve 45 is placed upon the threaded pipe with the stubborn nut with ample pressure. The base support plate 70 is positioned on the opposing side of the stubborn nut 64 with ample pressure. This process, with the aid of the action of a standard hand drill 90 and both support pillars 10, exerts enough pressure and support to safely remove most stubborn or corroded nuts.

Note that the invention will loosen virtually any type of nut that surrounds a pipe or tubing. Thus, it is not limited to compression nuts, to water supply lines, or the like. However, it is designed for service with compression nuts on water supply lines, for experience teaches that this is a very common problem area encountered by plumbers, both professional and amateur.

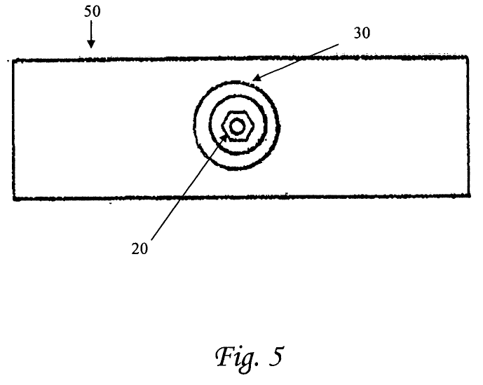

FIG. 5 shows an end-on view of the present invention. Attachment shaft 20, locking collar 30, and upper support plate 50 are seen in this view. A power source, such as a hand drill, would be attached to the present invention at this end. The lower plate, the turning axle, the pipe attachment sleeve, and the support pillars are obscured by the angle of this view.

While the above description contains many specificities, these should not be construed as limitations on the scope of the invention, but rather as exemplifications of one preferred embodiment thereof. Therefore, although the invention has been described in connection with a preferred embodiment or set of embodiments, it is not intended to limit the scope of the invention to the particular form set forth, but on the contrary, it is intended to cover such alternatives, modifications, and equivalents as may be included within the spirit and scope of the invention as defined by the appended claims.

I claim:

1. An apparatus for exerting force in a helical or spiral direction, said apparatus comprising:
An upper base plate;
A lower base plate, said lower plate incorporating a U-shaped cutaway area, allowing said lower plate to engage a nut or similar body;
Said upper plate being fixedly connected to said lower plate by means of a plurality of supporting pillars; and,
A central axle, which is perpendicularly arranged with respect to said upper plate, and passes through an aperture in said upper plate, and
approaches said cutaway area in said lower plate;
Said axle being capable of turning around its long axis;
Said axle being attached to a sleeve at its end closest to said lower plate;
Said axle being attached to an adapter at its opposite end;
Said adapter being suitable for engaging a powering device for supplying power to turn said axle in a helical or spiral direction.

2. The apparatus of claim 1, wherein said adapter is capable of engaging a power drill.

3. The apparatus of claim 1, wherein said adapter is capable of engaging a handle for hand turning of said axle.

4. The apparatus of claim 1, wherein said lower base plate is capable of engaging a threaded nut by means of inserting the nut into said cutaway area.

5. The apparatus of claim 1, wherein said sleeve is capable of engaging a water supply pipe.

6. The apparatus of claim 1, further comprising a locking collar.

7. The apparatus of claim 1, wherein said adapter comprises a metal shaft of hexagonal cross-section.

8. The apparatus of claim 1, wherein said sleeve can be exchanged with another sleeve of different diameter, to accommodate pipes of differing diameters.

9. The apparatus of claim 1, wherein said lower base plate can be exchanged with another plate of different cutaway area, to accommodate nuts of differing sizes.

10. A method for loosening tight or frozen nuts on pipes, the method comprising:
Exposing an end of the pipe near the nut, if necessary by cutting said pipe;
Inserting the sleeve of the apparatus of claim 1 into the open end of said pipe;
Engaging said nut with the cutaway area of the lower plate of said apparatus;
Engaging the attachment shaft of said apparatus with a power drill; and, Operating said power drill to apply turning force to said nut, thus freeing said nut from its frozen state.
